(19) United States
(12) Patent Application Publication
(10) Pub. No.: US 2013/0089312 A1
(43) Pub. Date: Apr. 11, 2013

(54) Camera Module

(71) Applicant: Chen-Yi HUANG, Taichung City (TW)

(72) Inventor: Chen-Yi HUANG, Taichung City (TW)

(73) Assignee: LARGAN PRECISION CO., LTD., Taichung City (TW)

(21) Appl. No.: 13/411,519

(22) Filed: Mar. 3, 2012

(30) Foreign Application Priority Data
Oct. 5, 2011 (TW) 100136063

(51) Int. Cl. G03B 17/00

(52) U.S. Cl. 396/77

(57) ABSTRACT

A camera module includes a base board, a holder, a conductive circuit, a camera lens and an electric-controlled light permissible element. A light sensing element is disposed on the base board, and a control signal is issued from the base board. The holder is connected to the base board and arranged on the light sensing element. The conductive circuit is arranged on the holder and electrically connected to the base board for receiving the control signal. The conductive circuit does not extend out of a surface of the holder. The camera lens has a lens and arranged with respect to the light sensing element. The electric-controlled light permissible element is electrically connected to the conductive circuit and arranged with respect to the light sensing element. The electric-controlled light permissible element changes its surface according to the control signal, thereby adjusting a focal length of the camera lens.

### RELATED APPLICATIONS

The application claims priority to Taiwan Application Serial Number 100136063, filed Oct. 5, 2011, which is herein incorporated by reference.

### BACKGROUND

1. Technical Field

The present disclosure relates to a photography module device. More particularly, the present disclosure relates to a holder device of a camera lens.

2. Description of Related Art

Refer to FIG. 1, FIG. 1 is a schematic diagram of a conventional camera module. As shown in FIG. 1, a camera module 100 includes a camera lens 110, an electric-controlled element 120, a first holder 130, a second holder 140, a pair of metal elements 150 and a pair of coupling elements 160.

The camera lens 110 has at least one lens 111. The electric-controlled element 120 is a liquid lens. The first holder 130 is used to hold the camera lens 110 and the electric-controlled element 120. The second holder 140 is used to hold the first holder 130, and the second holder 140 has a pair of conductive circuits 170. The metal elements 150 are assembled on the first holder 130, and the metal elements 150 communicate with the electric-controlled element 120 via a control signal by contact. The coupling elements 160 are used to transmit the control signal between the metal elements 150 and the conductive circuits 170.

The coupling elements 160 of the conventional camera module 100 electrically conducts the metal elements 150 and the conductive circuits 170 by contact, so that the conductive circuits 170 cannot avoid contact with an external conductor, thus resulting in an abnormal current loop. Furthermore, during the assembling process of the coupling elements 160 of the conventional camera module 100, the coupling elements 160 will have movements with respect to the metal elements 150 and the conductive circuits 170, and thus resulting in unwanted particle generation, which pollutes the production environment.

### SUMMARY

According to the first embodiment of the present invention, a camera module includes a base board, a holder, a conductive circuit, a camera lens and an electric-controlled light permissible element. There is a light sensing element disposed on the base board, and a control signal is issued from the base board. The holder is connected to the base board and is arranged on the outer side of the base board surrounding the light sensing element. The conductive circuit is arranged on the holder and is electrically connected to the base board for receiving the control signal, in which the conductive circuit does not extend out of a surface of the holder. The camera lens has at least one lens and is arranged with respect to the light sensing element. The electric-controlled light permissible element is electrically connected to the conductive circuit and is arranged with respect to the light sensing element, in which the electric-controlled light permissible element changes its surface according to the control signal, thereby adjusting a focal length of the camera lens.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic diagram of a conventional camera module;

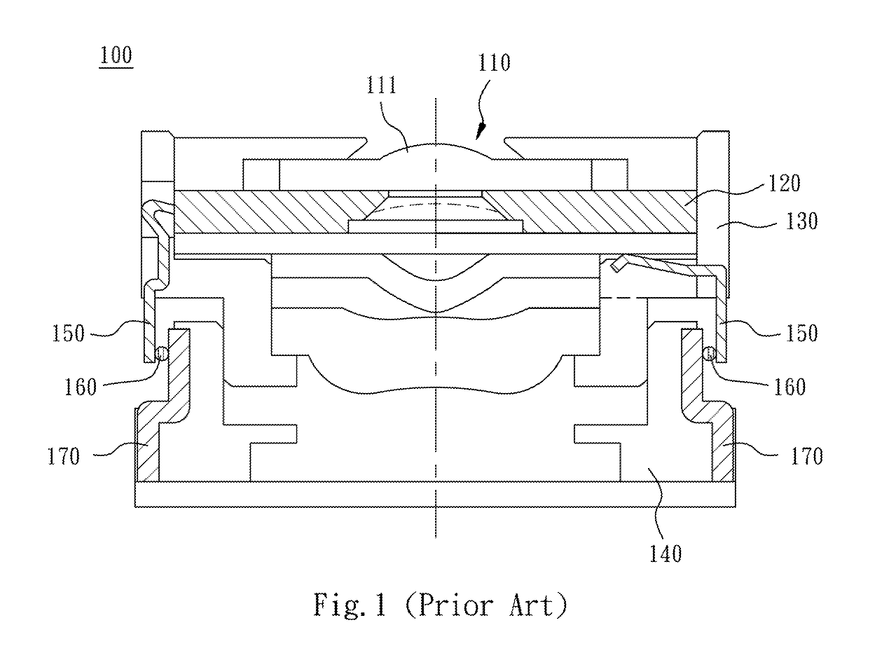

FIG. 2 is a schematic structure diagram of a camera module according to to the first embodiment of the present invention;

FIG. 3 is a partially enlarged diagram of the camera module shown in FIG. 2;

FIG. 4 is a schematic structure diagram of a camera module according to the second embodiment of the present invention;

FIG. 5 is a schematic structure diagram of a camera module according to third embodiment of the present invention; and

FIG. 6 is a partially enlarged diagram of the camera module shown in FIG. 5.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically depicted in order to simplify the drawings.

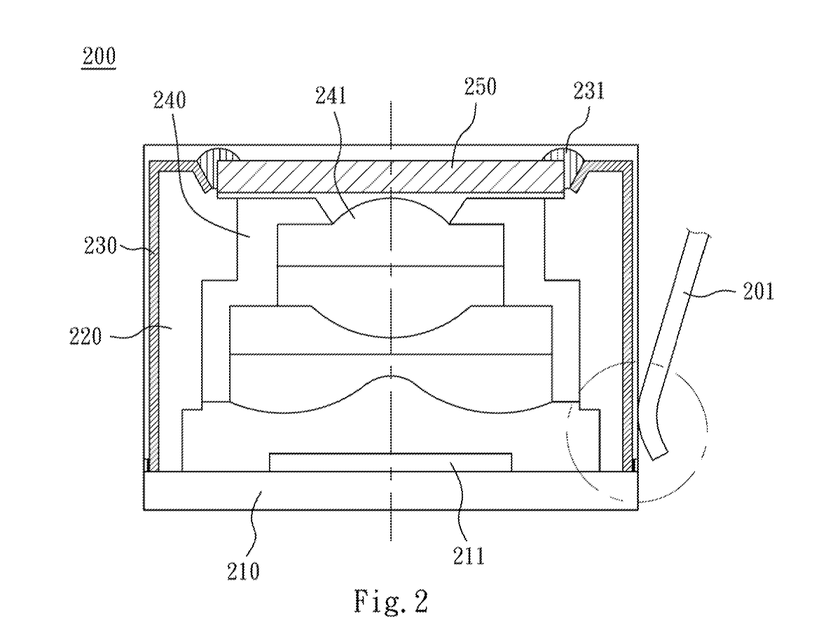

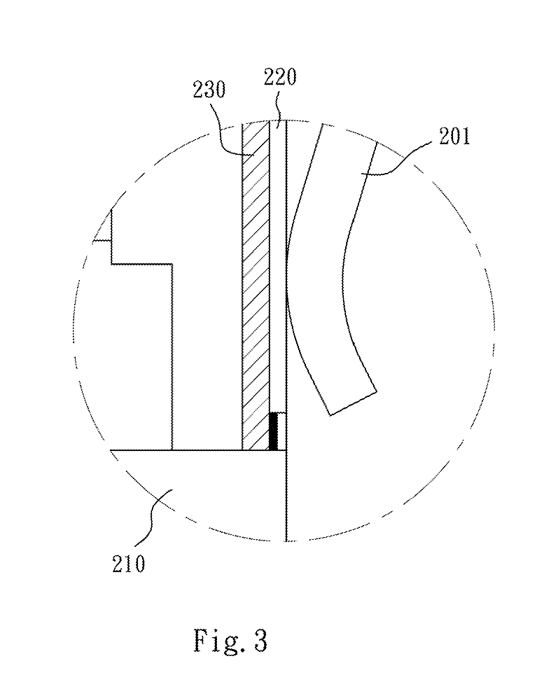

FIG. 2 is a schematic structure diagram of a camera module according to the first embodiment of the present invention. FIG. 3 is a partially enlarged diagram of the camera module shown in FIG. 2. As shown in FIG. 2 and FIG. 3, the camera module 200 includes a base board 210, a holder 220, a conductive circuit 230, a camera lens 240 and an electric-controlled light permissible element 250. There is a light sensing element 211 disposed on the base board 210, and a control signal is issued from the base board 210. The holder 220 is connected to the base board 210 and is arranged on the outer side of the base board surrounding the light sensing element 211.

The conductive circuit 230 is arranged on the holder 220 and is electrically connected to the base board 210 for receiving the control signal, in which the conductive circuit 230 does not extend out of a surface of the holder 220. The phrase “the conductive circuit 230 does not extend out of a surface of the holder 220” as used herein may include two situations that, (1) the conductive circuit 230 is arranged inside the holder 220; and (2) the conductive circuit 230 extends as far as the boundary aligned with a surface of the holder 220. The present embodiment is specifically referred to the situation that the conductive circuit 230 is arranged inside the holder 220, while the second situation will be described in other embodiments. The conductive circuit 230 is arranged on the holder 220 via a MID (Molded Interconnect Device) process which is a conventional skill and is not be described in detail herein. Moreover, the conductive circuit 230 can be arranged on the holder 220 by coating, printing, etching, electroplating or chemical electroplating in addition to the MID process. Similarly, these processes are also conventional skills, and thus are not described in detail herein. Although the term “or” is used herein to indicate the relationships among these processes, yet the implementation of the conductive circuit 230 may not be done by one single process. Therefore, other embodiments combining the aforementioned processes to implement the conductive circuit 230 still do not depart from the design spirit of the present embodiment.

It is worthy to be noted that the present embodiment forms the conductive circuit 230 directly on the holder 220, so that the amount of the parts constructing the camera module 200 can be reduced, thus simplifying assembly processes, and lowering cost. Furthermore, the conductive circuit 230 of the present embodiment is arranged inside the holder 220 for effectively preventing the conductive circuit 230 from contacting an external conductor 201, in which such a contact would lead to the conditions of unwanted short-circuit or current loop. Besides, the conductive circuit 230 of the present embodiment is arranged on the holder 220 via the MID process which has a high degree of freedom and may form the conductive circuit 230 on any non-specific positions or shapes, and thus can be used to form the conductive circuit 230 on the positions on which conventional skills such as insert molding and a metal assembly process cannot be used to perform the fabrication of the conductive circuit 230 due to the size or shape factor.

The camera lens 240 has at least one lens 241 and is arranged opposite to the light sensing element 211. The electric-controlled light permissible element 250 is electrically connected to the conductive circuit 230 and is arranged with respect to the light sensing element 211. The conductive circuit 230 is connected to the electric-controlled light permissible element 250 via a solder joint 231, and the conductive circuit 230 also can be seamless connected to the electric-controlled light permissible element 250 via a conductive adhesive in other embodiments. On the other hand, the electric-controlled light permissible element 250 changes its curved surface according to the control signal, thereby adjusting a focal length of the camera lens 240. In addition, the electric-controlled light permissible element 250 of the present embodiment is a liquid lens, and the electric-controlled light permissible element 250 also can be a liquid crystal in other embodiments. The aforementioned electric-controlled light permissible element 250 is controlled by voltage, current, PFM (Pulse Frequency Modulation) or PWM (Pulse Width Modulation) etc., so as to adjust its curved surface according to non-specific types of control signal. As described above, the term “or” is used herein for indicating different types of control signals. In addition to using one single type of control signal to control the electric-controlled light permissible element 250, the electric-controlled light permissible element 250 also can be actually controlled and adjusted by multiple control signals. Therefore, if other embodiments use the combination of the aforementioned control signals to control and adjust the curved surface of the electric-controlled light permissible element 250, and the embodiments will not depart from the spirit of the design of the present embodiment.

In practice, various types of metals can be coated on the surface of the conductive circuit 230 for improving the performance of the conductive circuit 230. For instance, gold coating on the conductive circuit 230 can improve the corrosion resistance and thermal conductivity of the conductive circuit 230.

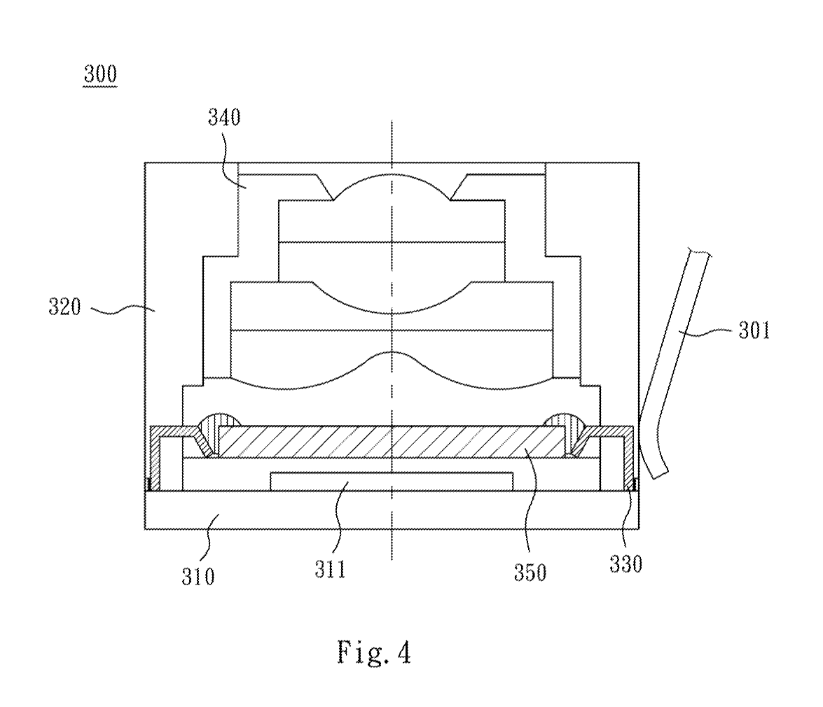

FIG. 4 is a schematic structure diagram of a camera module according to the second embodiment of the present invention. As shown in FIG. 4, the camera module 300 includes a base board 310, a holder 320, a conductive circuit 330, a camera lens 340 and an electric-controlled light permissible element 350. The camera module 300 of the present embodiment and the camera module 200 of the aforementioned embodiment are substantially similar, but are different in the relative positions of the light sensing elements 211, 311, the camera lenses 240, 340, and the electric-controlled light permissible elements 250, 350.

The camera module 200 of the aforementioned embodiment arranges the camera lens 240 between the electric-controlled light permissible element 250 and the light sensing element 211, but the camera module 300 of the present embodiment arranges the electric-controlled light permissible element 350 between the camera lens 340 and the light sensing element 311. The differences between the two embodiments caused by different positions are described as follows.

The conductive circuit 230 of the aforementioned embodiment is buried in the holder 220, such that it merely needs to connect the electric-controlled light permissible element 250 to the conductive circuit 230 via a solder joint 231. Thus, the design of arranging the camera lens 240 between the electric-controlled light permissible element 250 and the light sensing element 211 is relatively convenient for manufacture and assembly. On the other hand, besides the assembling order of the camera module 300 of the present embodiment is different from that of the aforementioned embodiment, since the electric-controlled light permissible element 350 is closer to the light sensing element 311, the required length of the conductive circuit 330 can be reduced, thus greatly lowering the cost of the conductive circuit 330.

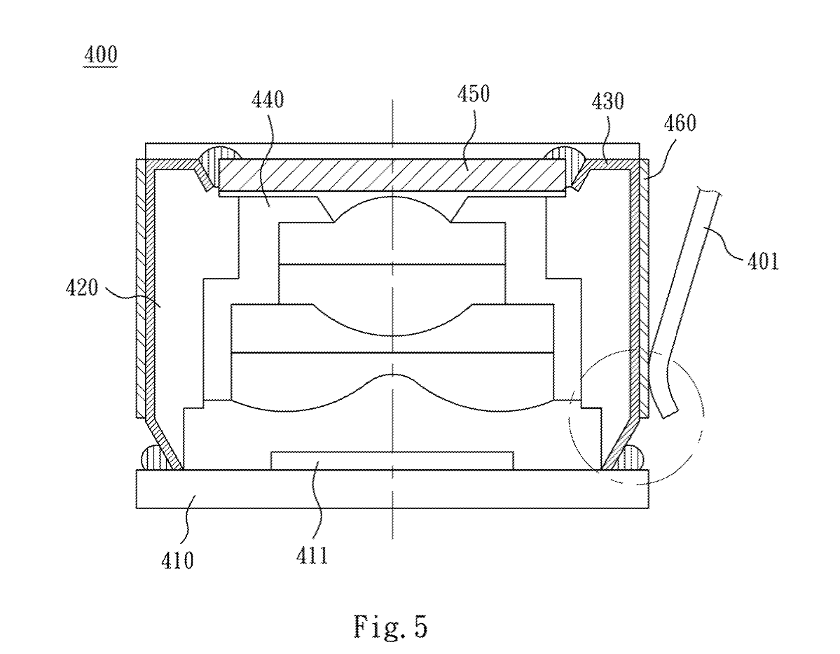

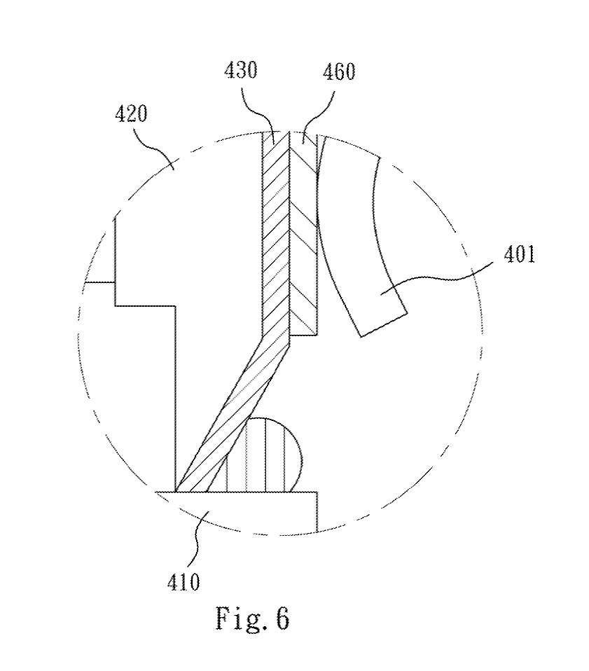

FIG. 5 is a schematic structure diagram of a camera module according to third embodiment of the present invention. FIG. 6 is a partially enlarged diagram of the camera module shown in FIG. 5. As shown in FIG. 5 and FIG. 6, the camera module 400 includes a base board 410, a holder 420, a conductive circuit 430, a camera lens 440 and an electric-controlled light permissible element 450. Because of many similarities between the camera module 400 of the present embodiment and the camera module 200 of the aforementioned embodiment, only the differences there between are described hereinafter.

The conductive circuit 430 is arranged on the holder 420 and is electrically connected to the base board 410 for receiving the control signal, in which the conductive circuit 430 does not extend out of a surface of the holder 420. The present embodiment will describe the situation that the conductive is circuit 430 extends as far as the boundary aligned with a surface of the holder 420. The conductive circuit 430 of the present embodiment is also arranged on the holder 220 via a MID (Molded Interconnect Device) process, in which the MID process is a conventional skill and will not be described herein. Moreover, the conductive circuit 430 also can be arranged on the holder 420 by coating, printing, etching, electroplating or chemical electroplating in addition to the MID process. The aforementioned processes are also conventional skills, and are not be described herein. Nevertheless, the term “or” is used herein to indicate the relationships among the process, yet the implementation of the conductive circuit 430 may not be done by one single process. Therefore, other embodiments combining the aforementioned processes to implement the conductive circuit 430 still do not depart from the design spirit of the present embodiment.

More particularly, an insulating layer 460 is arranged on a surface of the conductive circuit 430 for effectively preventing the conductive circuit 430 from contacting an external conductor 401, in which such a contact would lead to the conditions of unwanted short-circuit or current loop. As for the material of the insulating layer 460, it is a conventional skill and will not be described herein.

Besides, the technical features of the conductive circuit 430 extends as far as the boundary aligned with a surface of the holder 420 and the insulating layer 460 arranged on a surface of the conductive circuit 430 are different from the aforementioned embodiments, other technical features of the present embodiment are similar to the aforementioned embodiments and are not be described herein.

According to the aforementioned embodiments, the camera modules 200, 300 and 400 can not only prevent the conductive circuits 230, 330 and 430 from contacting to the external conductor which may cause abnormal current loop, but also reduces the manufacturing pollution toward the environment. In addition to solving the problem of the conventional skills, the camera modules 200, 300 and 400 of the present invention have the advantages of reducing the number of the parts of the camera module, simplifying the assembly processes, lowering cost and promoting the degree of freedom of arranging the conductive circuits 230, 330 and 430.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A camera module, comprising:
a base board on which a light sensing element is disposed, wherein a control signal is issued from the base board;
a holder which is connected to the base board and is arranged on the outer side of the base board surrounding the light sensing element;
a conductive circuit which is arranged on the holder and is electrically connected to the base board for receiving the control signal, wherein the conductive circuit does not extend out of a surface of the holder;
a camera lens which has at least one lens and is arranged with respect to the light sensing element; and
an electric-controlled light permissible element which is electrically connected to the conductive circuit and is arranged with respect to the light sensing element, wherein the electric-controlled light permissible element changes its surface according to the control signal, thereby adjusting a focal length of the camera lens.

2. The camera module of claim 1, wherein the light permissible element is controlled by voltage, current, PFM (Pulse Frequency Modulation) or PWM (Pulse Width Modulation).

3. The camera module of claim 1, wherein the camera lens is arranged between the electric-controlled light permissible element and the light sensing element.

4. The camera module of claim 1, wherein the electric-controlled light permissible element is arranged between the camera lens and the light sensing element.

5. The camera module of claim 1, wherein the conductive circuit is arranged on the holder via a MID (Molded Interconnect Device) process.

6. The camera module of claim 1, wherein the conductive circuit is arranged on the holder by coating, printing, etching, electroplating or chemical electroplating.

7. The camera module of claim 1, wherein the conductive circuit is connected to the electric-controlled light permissible element via a solder joint.

8. The camera module of claim 1, wherein the conductive circuit is seamless connected to the electric-controlled light permissible element via a conductive adhesive.

9. The camera module of claim 1, wherein the electric-controlled light permissible element is a liquid lens.

10. The camera module of claim 1, wherein the electric-controlled light permissible element is a liquid crystal.

11. The camera module of claim 1, wherein the conductive circuit is arranged inside the holder.

12. The camera module of claim 1, wherein the conductive circuit extends at most aligned with a surface of the holder.

13. The camera module of claim 12, further comprising:
an insulating layer which is arranged on a surface of the conductive circuit.
